(19) United States
(12) Patent Application Publication
(10) Pub. No.: US 2023/0339364 A1
(43) Pub. Date: Oct. 26, 2023

(54) ENERGY STORAGE DEVICE, MOTOR VEHICLE, AND METHOD FOR PRODUCING AN ENERGY STORAGE DEVICE

(71) Applicant: AUDI AG, Ingolstadt (DE)

(72) Inventors: Martin RIEBLINGER, Schrobenhausen (DE); Martin SCHÜSSLER, Kösching (DE)

(73) Assignee: AUDI AG, Ingolstadt (DE)

(21) Appl. No.: 18/187,956

(22) Filed: Mar. 22, 2023

(30) Foreign Application Priority Data
Apr. 21, 2022 (DE) 102022109655.6

(51) Int. Cl. H01M 10/613; B60L 58/26; H01M 10/625; H01M 10/6557

(52) U.S. Cl. CPC B60L 58/26; H01M 10/613; H01M 10/625; H01M 10/6557; H01M 2220/20

(57) ABSTRACT

An energy storage device with at least one battery cell and a cooling device for cooling the at least one battery cell. The battery cell has a first side, which is facing a first side of the cooling device, and a releasable degassing opening arranged on the first side, wherein the energy storage device has a thermal interface material, which is arranged between the first side the battery cell and the first side of the cooling device. The energy storage device has at least one degassing channel, into which a gas emerging from the releasable degassing opening can be introduced. A flow path from the releasable degassing opening to the at least one degassing channel is sealed off from an area surrounding the at least one battery cell by a seal, which is provided by the thermal interface material.

### FIELD

The invention relates to an energy storage device with at least one battery cell and a cooling device for cooling the at least one battery cell, wherein the battery cell has a first side that faces a first side of the cooling device, and a releasable degassing opening which is arranged on the first side of the battery cell. Furthermore, the energy storage device has a thermal interface material, which is arranged between the first side of the battery cell and the first side of the cooling device. In addition, the invention also relates to a motor vehicle and a method for producing an energy storage device.

### BACKGROUND

In the event of a so-called thermal runaway of a battery cell, gas is produced in the battery cell, which gas can escape from the cell in a controlled manner via a releasable degassing opening. Such a releasable degassing opening can be designed, for example, as a predetermined breaking point or bursting membrane or the like in the cell housing of the cell. In the case of such a thermal runaway, a quantity of gas with a high gas rate is produced, which means that a large quantity of gas escapes from such a cell in a very short time. This creates a corresponding pressure level within a closed battery system, which can be released to the environment, for example, by means of a pressure relief element. Without physical separation of the gas from current-carrying components or component connections, greater effort is required to protect and insulate these components. If this gas, which also comprises electrically conductive particles in particular, gets into the region of such current-carrying components, such as the region of the cell poles or cell connectors or module connectors, this can lead to short circuits, voltage breakdowns, and the like, and accordingly to a fire inside the battery. Attempts have therefore been made to spatially separate the gas from current-carrying components or component connections. However, this has so far only been possible in a relatively complex manner. If the releasable cell degassing opening is also on a side of the battery cell facing a cooling device, this separation is made even more difficult, since the provision of a path for gas discharge is severely limited in terms of installation space in this region and care must also be taken to ensure that the thermal connection of the cells to the cooling device does not suffer as a result. The introduction of seals, for example, then has the disadvantageous effect that it is no longer possible to achieve small gap widths between the first side of the battery cell and the first side of the cooling device. This correspondingly increases the thermal resistance of this thermal path. In addition, air pockets between such a seal and the thermal interface material cannot be avoided to date due to the manufacturing process. This also correspondingly leads to an increase in the thermal resistance in the region between the at least one battery cell and the cooling device.

DE 10 2011 103 993 A1 describes a battery with a plurality of cylindrical battery cells which are connected to a cooling element on at least one of the end faces of the battery cells via elastic tolerance compensation elements, in particular annular tolerance compensation elements, wherein an electrical insulating film is arranged between the battery cells and the cooling element, which film is designed in one piece with the tolerance compensation elements or is designed to be integrally connected thereto. The annular tolerance compensation element ensures free access to a bursting disk arranged in the center of the bottom region of the cell. This bursting disc corresponds to an opening in the region of the cooling element under each individual battery cell. A thermally conductive potting compound can also be arranged between the individual battery cell, tolerance compensation elements, and the cooling element provided with the insulating film.

Nevertheless, it is not possible to provide a small distance between the cells and the cooling element, primarily due to the tolerance compensation elements additionally arranged between the battery cells and the cooling element.

### SUMMARY

The object of the present invention is therefore to provide an energy storage device, a motor vehicle, and a method which, on the one hand, enable a battery cell to be connected to a cooling device in a way that is efficient in terms of installation space and, at the same time, enable the safest possible gas discharge from a battery cell in the least complex way in the event of a thermal runaway of such a battery cell.

This object is achieved by a an energy storage device, a motor vehicle, and a method with the features according to the respective independent claims. Advantageous embodiments of the invention are the subject matter of the dependent claims, the description, and the figures.

An energy storage device according to the invention has at least one battery cell and a cooling device for cooling the at least one battery cell. In this case, the battery cell comprises a first side, which faces a first side of the cooling device, and a releasable degassing opening, which is arranged on the first side of the battery cell. Furthermore, the energy storage device comprises a thermal interface material, which is arranged between the first side of the battery cell and the first side of the cooling device. In this case, the energy storage device has at least one degassing channel, into which a gas emerging from the releasable degassing opening can be introduced, wherein a flow path from the releasable degassing opening to the at least one degassing channel is sealed off from an area surrounding the at least one battery cell by a seal, which is provided by the thermal interface material.

The invention is based on the knowledge that thermal interface materials are known which are also suitable for sealing the flow path and can be used or optimized by an optional small modification with regard to the properties thereof for providing an additional sealing function. As a result, a separate seal can be dispensed with. This in turn results in further very great advantages: On the one hand, the connection surface via which the first side of the battery cell is thermally connected to the first side of the cooling device by means of the thermal interface material can be enlarged, since the region in which usually a separate seal would have to be arranged can then also be used. This in turn makes the thermal connection of the at least one battery cell to the cooling device much more efficient. In addition, the seal and thermal interface material no longer have to be applied or arranged in two separate manufacturing steps. This also eliminates the problem of air pockets between such a seal and the thermal interface material. Correspondingly, therefore, air pockets can also be avoided, which further reduces the thermal resistance between the battery cell and the cooling device. In addition, the problem of the different compressibility of the seal or sealing compound and the thermal interface material is then eliminated, which is why the minimum gap width between the first side of the battery cell and the first side of the cooling device is no longer limited by the properties of such a seal. Since the thermal interface material is introduced or applied in the viscous state, e.g. onto the first side of the cooling device and/or the first side of the at least one battery cell, the thermal interface material can also simultaneously take on the function of tolerance compensation in the setting direction, in which the at least one battery cell is placed on the cooling device or vice versa. Due to the elimination of the additional seal and the liquid or viscous material introduced, namely the thermal interface material, tolerance compensation is now possible in even larger tolerance ranges, and there is also no force loading on the mating parts, i.e. the at least one battery cell and the cooling device, after installation and crosslinking of the material, which would result, for example, with different materials for the thermal interface material and a separate seal. By eliminating the additional seal, costs and material can also be saved, and the manufacturing process is also simplified as a result. In addition, more connection surface for heat transfer is then possible in the same installation space with a greater sealing track width at the same time, since all the thermal interface material can then function as such a seal.

In principle, any materials known from the prior art which are used for the thermal connection between the battery cell and a cooling device can be considered the thermal interface material. These thermal interface materials are also often referred to as thermal compound or potting compound or gap filler. Such a thermal interface material preferably has the best possible thermal conductivity. When such an energy storage device is produced, such a thermal interface material is applied or introduced in viscous form, for example liquid, viscous, or pasty. For example, the thermal interface material can be applied in viscous form to the first side of the cooling device and then the at least one battery cell or a battery module or a cell stack with several such battery cells can be placed and pressure applied. Conversely, it is also conceivable to apply the thermal interface material to the first side of the battery cell or a cell stack and then to arrange this thermal interface material on the first side of the cooling device or to place the first side of the cooling device on the cell stack or in general the at least one battery cell. If the at least one battery cell, the thermal interface material, and the cooling device are ultimately arranged relative to one another as intended, the thermal interface material hardens. In the context of the present invention, it is also advantageous if the thermal interface material has good adhesive and cohesive properties. In particular, the thermal interface material can also function as an adhesive layer at the same time. Up to now, such adhesive properties have not been relevant. However, known thermal interface materials or previously used thermal interface materials can easily be modified by their material composition in such a way that they have the desired adhesive and/or cohesive properties, or such thermal interface materials which have the desired adhesive and/or cohesive properties can simply be selected. Due to the adhesive properties, the sealing function, which is then taken over by the thermal interface material in addition, is increased. Furthermore, both electrically conductive and electrically insulating materials are possible as the thermal interface material. An electrically insulating layer, for example in the form of an electrically insulating film, for example a plastic film, can also optionally be provided between the first side of the cooling device and the first side of the at least one battery cell. This film can be applied, for example, to the first side of the cooling device and/or to the first side of the at least one battery cell or the first side of a cell stack comprising the battery cell, which first side is defined in more detail later.

There is thus a gap between the first side of at least one battery cell or the cell stack comprising battery cells and the first side of the cooling device, which gap is at least partially filled with the thermal heat-conducting compound, in particular with the exception of free spaces to be explained later. This gap and thus also the thermal interface material layer extends in a plane which is essentially parallel to the first side of the at least one battery cell and the first side of the cooling device and which can be defined parallel to an xy-plane, wherein the x-direction corresponds to a first direction to be defined later, and the y-direction corresponds to a certain second direction to be defined later, which is perpendicular to the first direction. A gap height can be correspondingly defined in a third direction, which is perpendicular to the first and second directions and points, for example, from the first side of the cooling device to the first side of the at least one battery cell. The optional insulating films described above may be above or below the thermal interface material layer with respect to the third direction. It is also preferred that no further element or no further component, i.e. no separate tolerance compensation element or the like, apart from the thermal interface material, be arranged in the space between the at least one battery cell and the cooling device and in particular in the space between the cell stack comprising the at least one battery cell and the cooling device in the plane in which the thermal interface material is arranged. Except for one or more insulating layers, such as the films described above, there are preferably no further elements or layers arranged above or below the thermal interface material in the space between the at least one battery cell and the cooling device and in particular in the space between the cell stack comprising the at least one battery cell and the cooling device, even in the third direction.

The releasable degassing opening of the at least one battery cell can be provided in the form of a predetermined breaking point, for example in the form of a bursting membrane, or also as a pressure relief valve or the like. Furthermore, the releasable degassing opening is designed in such a way that it is closed during normal operation and is only released automatically in an emergency. This opening can, for example, open automatically when subjected to the increased internal pressure of the battery cell or due to an increased temperature of the battery cell or the like. The at least one battery cell can be formed, for example, as a lithium-ion cell. In addition, as will be explained in more detail later, the energy storage device can also comprise several such battery cells. These battery cells can also optionally be combined into battery modules. The energy storage device can be a high-voltage battery for a motor vehicle, for example. This battery can also act as a traction battery for the motor vehicle.

In principle, the battery cell can have any design, for example as a prismatic battery cell, round cell, or pouch cell. However, it is especially advantageous if the at least one battery cell is designed as a prismatic battery cell.

According to a further advantageous embodiment of the invention, the at least one battery cell has two cell poles, which are arranged on a side different from the first side of the battery cell, in particular wherein one pole each is arranged on a second side and a third side of the battery cell, which sides are opposite with respect to a first direction. The arrangement of the poles not on the first side is especially advantageous since this makes the connection to the cooling device much simpler. In addition, the gap widths between the battery cell and the cooling device can be minimized as a result. An especially great advantage of this arrangement is that the cell poles are not arranged on the same side as the releasable degassing opening. This simplifies the decoupling and separation of the flow path from the cell poles. This can increase safety even further. Furthermore, the battery cell preferably also has a fourth side, which is opposite the first side of the battery cell. The fourth side is preferably different from the second and third side of the battery cell, on which the cell poles are arranged. This has the great advantage that a further, second cooling device can also be arranged, for example, on the fourth side of the battery cell. The first cooling device and/or the second cooling device can be designed as cooling plates, for example. In general, the cooling device is designed such that a coolant can flow through it and, for this purpose, has cooling channels, for example, through which such a coolant flows during operation. Based on the intended installation position of the energy storage device in a motor vehicle, the first side of the battery cell can represent a bottom side, for example, and the opposite fourth side can represent a top side of the battery cell. If the energy storage device comprises several battery cells in the form of a cell stack, these battery cells can be arranged next to one another and connected to a common first and/or second cooling device. An especially efficient cooling mechanism and an especially simple implementation of this cooling can thereby be provided.

Accordingly, a further very advantageous embodiment of the invention is represented when the energy storage device has a cell stack with several of the at least one battery cell, wherein the several battery cells are arranged next to one another in a second direction, wherein the releaseable degassing openings are arranged in the second direction on an imaginary straight line in a first region of the cell stack, which represents a partial region of a first stack side facing the first side of the cooling device and comprising the first sides of the battery cells. The second direction can in particular be oriented perpendicular to the first direction defined above. The battery cells are preferably arranged in the cell stack in such a way that the sides thereof with the largest surface area face each other. This makes it possible to provide an especially efficient structure. The fact that the respective degassing openings in this case are arranged along an imaginary line also has design advantages. This makes it possible to connect the releasable degassing openings to a common degassing channel in a simple manner. In addition, the sealing of the flow path is also simpler as a result, since this can accordingly be accomplished by a single circumferential seal provided by the thermal interface material.

Accordingly, a further advantageous embodiment of the invention is represented when the thermal interface material is arranged between the first cell stack side and the first side of the cooling device in such a way that the first region of the cell stack, in which the respective releasable degassing openings are arranged, is recessed. In the event of a thermal event, this recessed region advantageously does not prevent the gas from escaping from the released degassing opening in question. At the same time, the region made available as a result can be used as a degassing channel, at least in a first phase of the gas release.

Consequently, a further very advantageous embodiment of the invention is represented when a free region is formed between the first region of the cell stack on the first side of the cooling device, which free region represents a first degassing channel as the at least one degassing channel. The free region is formed in particular in that it is recessed to provide the thermal interface material. If thermal runaway occurs in a battery cell, the gas from this battery cell first exits from the releasable degassing opening thereof and enters this free region between the battery cell and the first side of the cooling device. This region is then advantageously sealed laterally by the thermal interface material and therefore cannot get into an area surrounding the battery cell in which, for example, the cell poles of the battery cell are also arranged. In the case of a thermal event, this free region is preferably used as the first degassing channel in a first phase of the gas release. This first phase is limited to a very short period of time after the releasable degassing opening has been opened, for example to a period of a few seconds, in particular to a period of approximately one second. Subsequently, so much gas escapes from the battery cell that it makes its way through the cooling device underneath. The cooling device in this case can also be designed with one or more predetermined breaking points, for example. These predetermined breaking points can be positioned, for example, below a respective releasable degassing opening. In general, these predetermined breaking points are thus, for example, opposite the releasable degassing openings with respect to a third direction, which is perpendicular to the first and second directions defined above. In the region in which these predetermined breaking points are provided in the cooling device, the cooling device preferably has no cooling channels. This facilitates penetration of the cooling device in the event of degassing.

Accordingly, a further very advantageous embodiment of the invention is represented if the energy storage device has a second degassing channel as the at least one degassing channel on a second side of the cooling device facing away from the battery cell. As a result, the gas escaping from the released degassing opening of the at least one battery cell can pass through, for example, the described predetermined breaking point in the cooling device and enter this second degassing channel. This second degassing channel can be designed in such a way that it discharges the gas from the motor vehicle in which the energy storage device is being used. The gas, for example, can be routed to or routed through an underbody region or a region between the cooling device and an underride guard of the motor vehicle up to a corresponding release region.

Accordingly, the gas then enters the second degassing channel in a second phase of degassing a battery cell. The second phase can immediately follow the first phase defined above.

According to a further advantageous embodiment of the invention, the thermal interface material is arranged in the form of at least one layer between the first side of the at least one battery cell, in particular the first cell stack side, and the first side of the cooling device, in particular wherein the at least one layer has a layer thickness of at most two millimeters in a third direction. For example, the layer thickness can be between 0.2 millimeters and 1.5 millimeters, in particular between one millimeter and 1.5 millimeters. This means that extremely small layer thicknesses can be provided, as a result of which the thermal resistance between the battery cell and the cooling device can be kept very low. In addition, installation space can be saved as a result. This material layer of the thermal interface material can also be divided into several sections. For example, the thermal interface material can also be provided in the form of two layers, each being arranged on one side with respect to the first direction of the free region defined above. These two layers or layer sections can also be connected to one another, for example in a respective end region of this free region in relation to the second direction. The thermal interface material layers can therefore optionally completely enclose the free region in the xy-plane. If several layers of the thermal interface material are provided, they are, however, arranged in a common plane and not one above one another approximately in the third direction. Except for tolerance-related fluctuations, the layer thickness is preferably essentially constant over the entire layer of the thermal interface material.

Furthermore, the energy storage device can also have several of such cell stacks. These cell stacks can, for example, be arranged next to one another, for example next to one another in the first direction and/or next to one another in the second direction. Furthermore, these cell stacks can be accommodated in a common battery housing as part of the energy storage device. A base of such a battery housing can be provided, for example, by the described cooling device. A cover of the battery housing can also be designed, for example, as a further second cooling device, which has also already been described.

Furthermore, the invention also relates to a motor vehicle having an energy storage device according to the invention or one of the designs thereof.

The motor vehicle according to the invention is preferably designed as an automobile, in particular as a passenger car or truck, or as a passenger bus or motorcycle.

Furthermore, the invention also relates to a method for producing at least part of an energy storage device, wherein at least one battery cell is provided, which has a first side and a releasable degassing opening arranged on the first side. Furthermore, a cooling device is provided which has a first side and which is provided for cooling the at least one battery cell. Furthermore, a thermal interface material is provided in a viscous state. Incidentally, the thermal interface material can also be composed of several components which are only mixed shortly before application. Furthermore, the at least one battery cell, the thermal interface material, and the cooling device are arranged relative to one another in such a way that the first side of the battery cell faces the first side of the cooling device and the thermal interface material is arranged between the first side of the battery cell and the first side of the cooling device. Furthermore, at least one degassing channel is provided such that a gas emerging from the releasable degassing opening can be introduced, wherein a flow path from the releasable degassing opening to the at least one degassing channel is sealed off from an area surrounding the at least one battery cell by a seal, which is provided by the thermal interface material.

The advantages described for the energy storage device according to the invention and the embodiments thereof thus apply similarly to the method according to the invention.

As described above, the thermal interface material can be arranged between the at least one battery cell and the cooling device. For this purpose, this interface material is preferably either applied to the first side of the cooling device and then the at least one battery cell is placed thereon; or, vice versa, it is applied to the first side of the battery cell and then the cooling device is arranged thereon. The battery cell and the cooling device can be pressed against each other so that the thermal interface material is distributed accordingly. The amount of thermal interface material applied in the corresponding application regions of the cooling device and/or the at least one battery cell ensures that the thermal interface material does not get into the free region which is to be kept free, as defined above. In addition, the thermal interface material can have a correspondingly viscous state during the application and during the arranging of the battery cell on the cooling device to ensure that the thermal interface material does not get into this free region. For example, the thermal interface material may be viscous or pasty. After the battery cell, the thermal interface material, and the cooling device are arranged relative to each other as intended, the thermal interface material hardens.

The invention also includes refinements of the method according to the invention, which comprise features as have already been described in conjunction with the refinements of the energy storage device according to the invention. For this reason, the corresponding refinements of the method according to the invention are not described again here.

The invention also comprises the combinations of the features of the described embodiments. The invention also comprises implementations which each have a combination of the features of several of the described embodiments, unless the embodiments were described as being mutually exclusive.

### BRIEF DESCRIPTION OF THE FIGURES

Exemplary embodiments of the invention are described hereinafter. In the figures:

FIG. 1 shows a schematic cross-sectional representation through a part of an energy storage device with a battery cell and a cooling device according to an exemplary embodiment of the invention; and

FIG. 2 shows a schematic representation of a plan view of a bottom side of a cell stack with thermal interface material arranged thereon according to an exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also refine the invention independently of one another. Therefore, the disclosure is also intended to comprise combinations of the features of the embodiments other than those represented. Furthermore, the described embodiments can also be supplemented by further features of the invention as already described.

In the figures, same reference numerals respectively designate elements that have the same function.

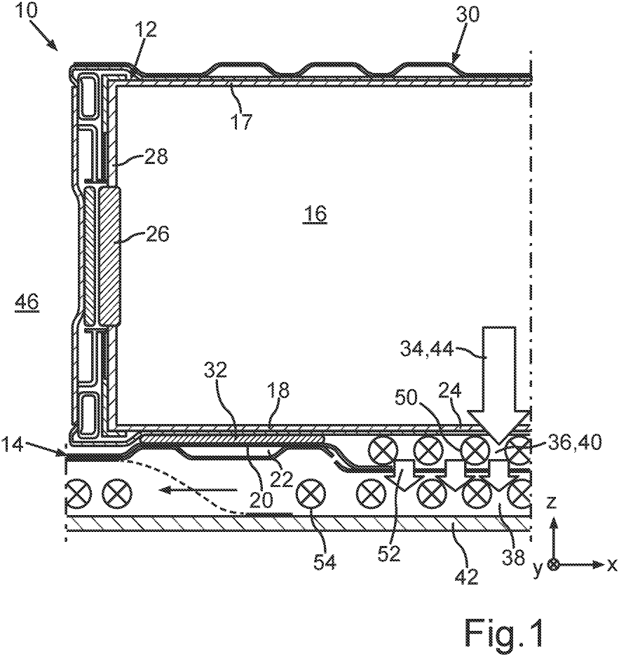

FIG. 1 shows a schematic representation of part of an energy storage device 10 in a cross-section through a battery cell 12 and a cooling device 14 as part of the energy storage device 10 according to an exemplary embodiment of the invention. In this example, the battery cell 12 is designed as a prismatic battery cell and has a cell interior 16 which is enclosed by a cell housing 17. Furthermore, the battery cell 12 comprises a first side 18 which faces a first side 20 of the cooling device 14. The cooling device 14 is also embodied as a cooling base and comprises cooling channels 22 through which a coolant can flow. Furthermore, the battery cell 12 also has a releasable degassing opening 24 on the first side 18, which is embodied here as a bursting membrane. In addition, the battery cell 12 comprises two cell poles 26, of which only one is shown here. The cell poles 26 are located on opposite sides of the battery cell 12 with respect to the x-direction shown, namely on a second side 28 and a third side (not shown). The cell poles 26 are therefore not arranged on the first side 18 of the battery cell 12. A further second cooling device 30 is optionally arranged above the battery cell 12. Only approximately half of the battery cell 12 is shown in cross-section in FIG. 1, but the other half can be mirror-symmetrical with respect to a mirror plane parallel to the yz-plane through approximately the center of the degassing opening 24. This also applies to the other components shown in FIG. 1, especially the cooling device 14 and the thermal interface material layer 32 described below.

In order to improve the thermal connection of the battery cell 12 to the cooling device 14, a thermal interface material 32 is arranged between the battery cell 12, in particular its first side 18, and the first side 20 of the cooling device 14. When the energy storage device 10 is being produced, it is in a viscous state at the time it is introduced or applied to the cell 12 and/or the first side 20 of the cooling device 14 and then hardens. The thermal interface material 32 is applied in the form of a layer which, when the battery cell 12 is arranged as intended with respect to the cooling device 14, has a layer thickness in the z-direction of preferably at most two millimeters.

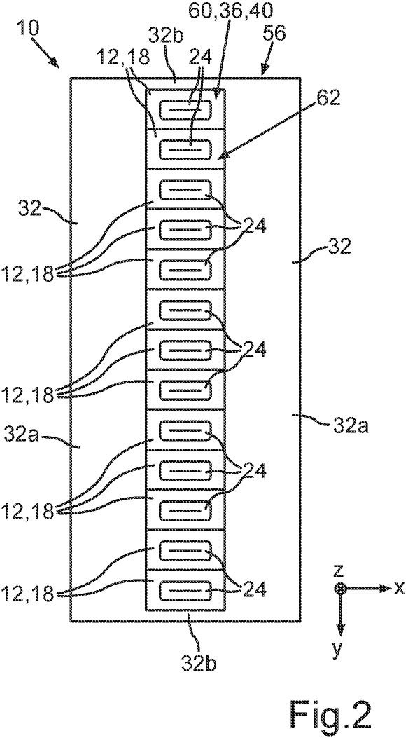

In the event of a thermal runaway of the battery cell 12, the gas 34 emerging from the cell 12, which is illustrated here by arrows, must be discharged as efficiently as possible. The arrows shown illustrate not only the gas 34 itself, but also the flow path 44 along which the gas 34 flows at least in part. In this example, a first degassing channel 36 and a second degassing channel 38 are provided for discharging the gas 34. The first degassing channel 36 is provided by a free region 40 which is arranged directly below the releasable degassing opening 24 in the direction opposite the z-direction. This free region 40 is therefore located between the first side 20 of the cooling device 14 and the first side 18 of the cell 12. In addition, this free region 40 extends in or opposite the y-direction, for example also over several releasable degassing openings 24 of further battery cells 12 which are arranged in or opposite the y-direction next to the battery cell 12 shown and can be part of a cell stack 46 (cf. FIG. 2) together therewith. In addition, the second degassing channel 38 is arranged on the opposite side of the cooling device 14. In particular, this second degassing channel 38 is located between an underride guard 42 of the motor vehicle and the cooling device 14.

In the case of degassing, it should ideally be ensured that the escaping gas 34 cannot get into the region of electrically conductive parts and live parts of the energy storage device 10. This can now advantageously be provided by a seal which seals off the flow path 44 of the gas 34, which flow path is represented in the same way by the arrows shown, from an area surrounding 46 the battery cell 12. This seal is now advantageously provided by the thermal interface material 32 itself. This advantageously ensures that the escaping gas 34 cannot get through the gap between the cell 12 and the cooling device 14 and into other regions of the interior of the energy storage device 10, which are referred to here as an area surrounding 46 the cell 12. This also ensures that the gas 34 cannot get into the region of the poles 26 of the cell 12. The seal 32 thus also functions at the same time as a particle barrier for the particles contained or entrained in the escaping gas 34. In the case of a thermal event, the gas 34 first enters the first degassing channel 36 through the then released degassing opening 24 and can flow in or opposite the y-direction. This is illustrated by flow symbols 50. In a second phase of the gas release, it penetrates into the cooling device 14, for example in the region of predetermined breaking points 52, and correspondingly penetrates into the second degassing channel 38. The flow can also flow through this degassing channel in and opposite the y-direction, which is illustrated by the further flow symbols 54. In addition, the gas can also flow in the direction opposite the x-direction, as shown here, and be routed to a release opening from the motor vehicle.

FIG. 2 again shows a schematic representation of a part of an energy storage device 10 according to an exemplary embodiment of the invention. Otherwise, the energy storage device 10 can be designed as already described for FIG. 1. FIG. 2 then shows a battery module 56 which represents or comprises a cell stack 56 which in turn comprises several battery cells 12 arranged next to one another in the y-direction. This battery module is shown in a plan view from below without the cooling device 14 shown, but with the thermal interface material 32 arranged on the cell stack 56. The respective releasable degassing openings 24 of the respective cells are arranged along an imaginary straight line, which extends in the y-direction in the present example. These cells are arranged in a first region 60 of the cell stack 56, in particular a bottom side 62 of the cell stack 12. Furthermore, the thermal interface material 32 is arranged on this bottom side 62 of the cell stack 12. This is arranged in such a way that this first region 60 of the bottom side 62 of the cell stack 12 is recessed. As a result, the free region 40, which functions as the first degassing channel 36, is made available. In particular, the thermal interface material 32 comprises at least two material regions 32a, one each of which is arranged next to the recessed region 60 in and opposite the x-direction. Optionally, two further regions 32b can also be provided, one each of which is arranged in and opposite the y-direction next to the recessed region 60 and the other regions 32a of the thermal interface material 32. In this case, the thermal interface material 32 frames the recessed region 60 as it were. In these optional regions 32b, the thermal interface material 32 can be narrower depending on the installation space situation; in particular, the regions 32b can be narrower in the y-direction depending on the situation, namely in the event that there is no relevance at this point or at least no significant relevance for a thermal connection of this region.

Overall, the examples show how the invention can provide a sealing function for gas routing in the case of cell degassing. In this case, a thermal interface material with optionally adapted properties is used, which is simultaneously also used as a seal for sealing off the at least one degassing channel. The elimination of the seal and the reserve surface area for the production process is used for a broad connection of the cell module to the housing, i.e. the cooling base providing the cooling device by means of the thermal interface material. As a result, more surface area is provided for the thermal connection of the cell module to the housing, as well as a wider sealing track for sealing off the gas channel.

1. An energy storage device, comprising:
at least one battery cell and a cooling device for cooling the at least one battery cell, the battery cell has a first side facing a first side of the cooling device, and a releasable degassing opening which is arranged on the first side of the battery cell; and the energy storage device has a thermal interface material which is arranged between the first side of the battery cell and the first side of the cooling device,
wherein the energy storage device has at least one degassing channel, into which a gas emerging from the releasable degassing opening can be introduced, wherein a flow path from the releasable degassing opening to the at least one degassing channel is sealed off from an area surrounding the at least one battery cell by a seal, which is provided by the thermal interface material.

2. The energy storage device according to claim 1, wherein the at least one battery cell is designed as a prismatic battery cell.

3. The energy storage device according to claim 1, wherein the at least one battery cell has two cell poles which are arranged on a side different from the first side of the battery cell, in particular wherein one pole each is arranged on a second side and a third side of the battery cell, which are opposite one another with respect to a first direction.

4. The energy storage device according to claim 1, wherein the energy storage device has a cell stack with several of the at least one battery cell, wherein the several battery cells are arranged next to one another in a second direction, wherein the releasable degassing openings are arranged in the second direction on an imaginary straight line in a first region of the cell stack, which represents a partial region of a first cell stack side facing the first side of the cooling device and comprising the first sides of the battery cells.

5. The energy storage device according to claim 4, wherein the thermal interface material is arranged between the first cell stack side and the first side of the cooling device in such a way that the first region of the cell stack, in which the respective releasable degassing opening s are arranged, is recessed.

6. The energy storage device according to claim 1, wherein the thermal interface material is arranged in the form of at least one layer between the first side of the at least one battery cell, in particular the first cell stack side, and the first side of the cooling device, in particular wherein the at least one layer has a layer thickness of at most 2 mm in a third direction.

7. The energy storage device according to claim 1, wherein a free region is formed between the first region of the cell stack and the first side of the cooling device, which free region represents a first degassing channel as the at least one degassing channel.

8. The energy storage device according to claim 1, wherein the energy storage device has a second degassing channel as the at least one degassing channel on a second side of the cooling device facing away from the battery cell.

9. A motor vehicle having an energy storage device of claim 1.

10. A method for producing at least a part of an energy storage device, comprising the steps:
providing at least one battery cell, which has a first side and a releasable degassing opening arranged on the first side, and a cooling device, which has a first side, for cooling the at least one battery cell,
providing a thermal interface material in a viscous state;
arranging the at least one battery cell, the thermal interface material, and the cooling device relative to one another in such a way that the first side of the battery cell faces the first side of the cooling device and the thermal interface material is arranged between the first side of the battery cell and the first side of the cooling device,
wherein at least one degassing channel is provided such that a gas emerging from the releasable degassing opening can be introduced, wherein a flow path from the releasable degassing opening to the at least one degassing channel is sealed off from an area surrounding the at least one battery cell by a seal, which is provided by the thermal interface material.

11. The energy storage device according to claim 2, wherein the at least one battery cell has two cell poles which are arranged on a side different from the first side of the battery cell, in particular wherein one pole each is arranged on a second side and a third side of the battery cell, which are opposite one another with respect to a first direction.

12. The energy storage device according to claim 2, wherein the energy storage device has a cell stack with several of the at least one battery cell, wherein the several battery cells are arranged next to one another in a second direction, wherein the releasable degassing openings are arranged in the second direction on an imaginary straight line in a first region of the cell stack, which represents a partial region of a first cell stack side facing the first side of the cooling device and comprising the first sides of the battery cells.

13. The energy storage device according to claim 3, wherein the energy storage device has a cell stack with several of the at least one battery cell, wherein the several battery cells are arranged next to one another in a second direction, wherein the releasable degassing openings are arranged in the second direction on an imaginary straight line in a first region of the cell stack, which represents a partial region of a first cell stack side facing the first side of the cooling device and comprising the first sides of the battery cells.

14. The energy storage device according to claim 2, wherein the thermal interface material is arranged in the form of at least one layer between the first side of the at least one battery cell, in particular the first cell stack side, and the first side of the cooling device, in particular wherein the at least one layer has a layer thickness of at most 2 mm in a third direction.

15. The energy storage device according to claim 3, wherein the thermal interface material is arranged in the form of at least one layer between the first side of the at least one battery cell, in particular the first cell stack side, and the first side of the cooling device, in particular wherein the at least one layer has a layer thickness of at most 2 mm in a third direction.

16. The energy storage device according to claim 4, wherein the thermal interface material is arranged in the form of at least one layer between the first side of the at least one battery cell, in particular the first cell stack side, and the first side of the cooling device, in particular wherein the at least one layer has a layer thickness of at most 2 mm in a third direction.

17. The energy storage device according to claim 5, wherein the thermal interface material is arranged in the form of at least one layer between the first side of the at least one battery cell, in particular the first cell stack side, and the first side of the cooling device, in particular wherein the at least one layer has a layer thickness of at most 2 mm in a third direction.

18. The energy storage device according to claim 2, wherein a free region is formed between the first region of the cell stack and the first side of the cooling device, which free region represents a first degassing channel as the at least one degassing channel.

19. The energy storage device according to claim 3, wherein a free region is formed between the first region of the cell stack and the first side of the cooling device, which free region represents a first degassing channel as the at least one degassing channel.

20. The energy storage device according to claim 4, wherein a free region is formed between the first region of the cell stack and the first side of the cooling device, which free region represents a first degassing channel as the at least one degassing channel.
